(19) United States
(12) Patent Application Publication
(10) Pub. No.: US 2013/0249465 A1
(43) Pub. Date: Sep. 26, 2013

(54) MOTOR CONTROL APPARATUS

(71) Applicant: KABUSHIKI KAISHA YASKAWA DENKI, Kitakyushu-shi (JP)

(72) Inventors: Koichi KIRIHARA, Kitakyushu-shi (JP); Yasufumi YOSHIURA, Kitakyushu-shi (JP); Yasuhiko KAKU, Kitakyushu-shi (JP)

(73) Assignee: KABUSHIKI KAISHA YASKAWA DENKI, Kitakyushu-shi (JP)

(21) Appl. No.: 13/773,640

(22) Filed: Feb. 22, 2013

(30) Foreign Application Priority Data
Mar. 23, 2012 (JP) 2012-066551

(51) Int. Cl. H02P 29/00

(52) U.S. Cl. CPC H02P 29/00
USPC 318/632

(57) ABSTRACT

A motor control apparatus includes a position controller that generates a velocity command on the basis of a position difference between a position command and a position feedback signal, a switcher that switches the position feedback signal to be input to the position controller from a first position signal detected by a laser interferometer to a second position signal detected by a position sensor, and a phase compensator that compensates for a phase delay of the second position signal switched by the switcher relative to the first position signal.

### CROSS-REFERENCE TO RELATED APPLICATIONS

The present disclosure contains subject matter related to that disclosed in Japanese Priority Patent Application JP 2012-066551 filed in the Japan Patent Office on Mar. 23, 2012, the entire contents of which are hereby incorporated by reference.

### BACKGROUND OF THE INVENTION

1. Field of the Invention

The disclosed embodiment relates to a motor control apparatus.

2. Description of the Related Art

Japanese Unexamined Patent Application Publication No. 2004-349494 discloses a technology related to a workpiece stage that positions a table holding a workpiece thereon by moving the table in any directions. The workpiece stage includes a laser interferometer that measures the position of the table using a laser beam, a position measuring device used to position the table, and a controller that determines whether or not the position data obtained by the laser interferometer is normal and that obtains an error in the positioning of the table on the basis of the position data obtained by the laser interferometer when the position data is determined as normal.

### SUMMARY OF THE INVENTION

According to an aspect of the disclosure, there is provided motor control apparatus including a position controller that generates a velocity command on the basis of a position difference between a position command and a position feedback signal, a switcher that switches the position feedback signal to be input to the position controller from one of a first position signal detected by a first position detector and a second position signal detected by a second position detector to the other, and a phase compensator that compensates for a phase delay of the first position signal or the second position signal switched by the switcher.

### BRIEF DESCRIPTION OF THE DRAWINGS

FIG. 1 is a schematic view of a motor control system including a motor control apparatus according to an embodiment.

FIG. 2 is a schematic block diagram of the motor control apparatus.

FIG. 3 is a block diagram of an example of the detailed structure of the motor control apparatus.

FIG. 4 is a block diagram of an example of the structure of a phase compensator.

FIG. 5A shows a waveform graph of a command velocity of a motor control apparatus that does not include a phase compensator, and FIG. 5B shows a waveform graph of a command velocity of a motor control apparatus that includes a phase compensator.

FIG. 6 is a schematic block diagram of a motor control apparatus that corrects a position signal by using a correlation table.

### DESCRIPTION OF THE EMBODIMENTS

Hereinafter, an embodiment will be described with reference to the drawings.

### Structure of Motor Control System

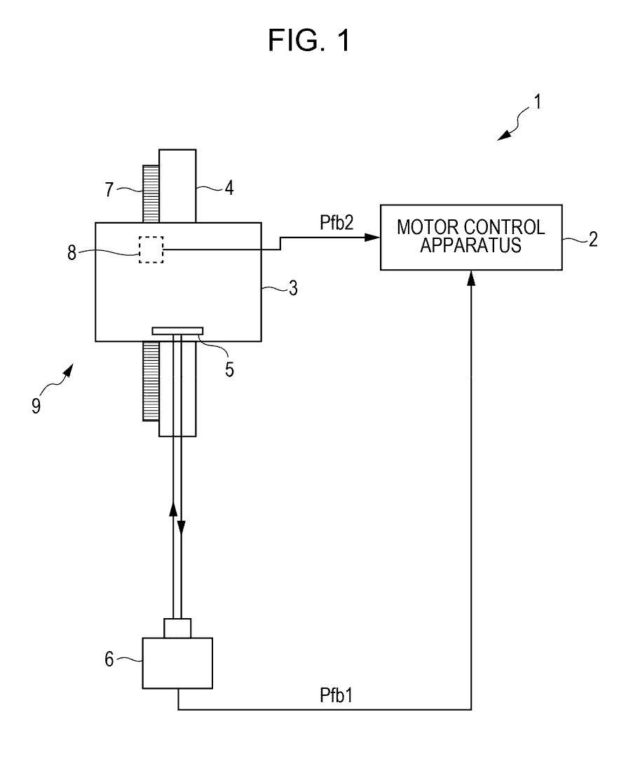

As illustrated in FIG. 1, a motor control system 1 includes a motor control apparatus 2, a controlled object 9, a laser interferometer 6 (first position detector), and a position sensor 8 (second position detector). The controlled object 9 includes a workpiece stage 3 and a linear guide 4 that supports the workpiece stage 3 so that the workpiece stage 3 can move in the front-back direction (the vertical direction in FIG. 1). The laser interferometer 6 is disposed so as to face a reflection mirror 5 disposed on the workpiece stage 3. A linear scale 7 is disposed, for example, on one side of the linear guide 4 in the width direction of the linear guide 4, and the position sensor 8 is disposed so as to face the linear scale 7 with a predetermined gap therebetween.

The laser interferometer 6 emits a laser beam toward the reflection mirror 5 and receives a reflected laser beam reflected from the reflection mirror 5, thereby detecting the position (movement amount) of the workpiece stage 3 in the movement direction, that is, the position of the controlled object 9. Position data detected by the laser interferometer 6 (hereinafter referred to as a “first position signal Pfb1”) is input to the motor control apparatus 2 as a position feedback signal and is used to control the position of the controlled object 9. The position sensor 8 optically or magnetically reads position marks on the linear scale 7, thereby detecting the position (movement amount) of the workpiece stage 3 in the movement direction, that is, the position of the controlled object 9. Position data of the controlled object 9 detected by the position sensor 8 (hereinafter referred to as a “second position signal Pfb2”) is input to the motor control apparatus 2 as a position feedback signal and is used to control the position of the controlled object 9.

### Structure of Motor Control Apparatus

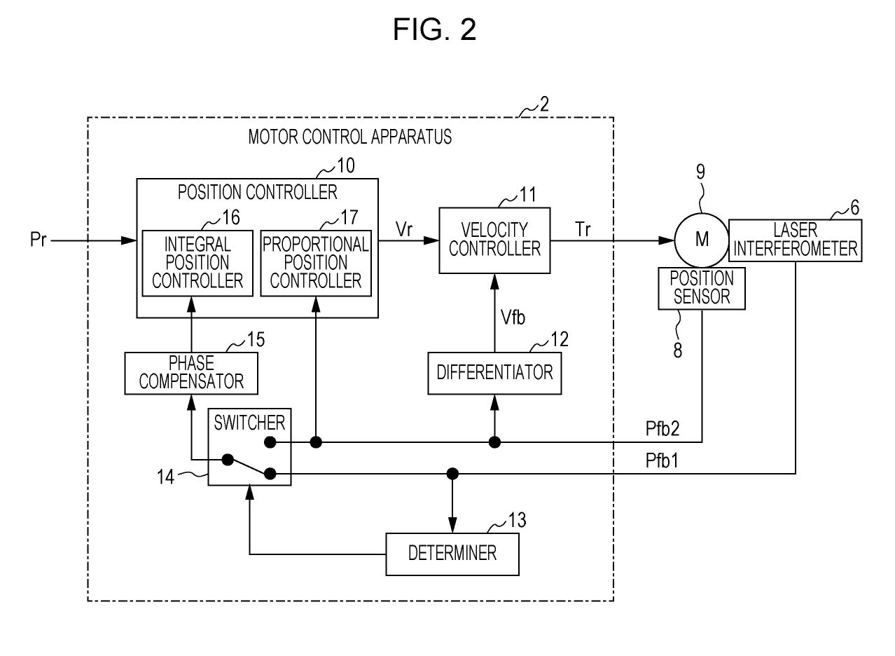

As illustrated in FIG. 2, the motor control apparatus 2 includes a position controller 10, a velocity controller 11, a differentiator 12, a determiner 13, a switcher 14, and a phase compensator 15. The position controller 10 includes an integral position controller 16 that performs integral position control on the basis of the first position signal Pfb1 and a proportional position controller 17 that performs proportional position control on the basis of the second position signal Pfb2. The position controller 10 generates a velocity command Vr on the basis of the position difference between a position command Pr input to the position controller 10 and the position feedback signals (the first position signal Pfb1 and the second position signal Pfb2). The velocity controller 11 generates a torque command Tr on the basis of the velocity difference between the velocity command Vr output from the position controller 10 and a velocity feedback signal Vfb generated by the differentiator 12 by differentiating the second position signal Pfb2.

The switcher 14 switches the position feedback signal to be input to the integral position controller 16 from one of the first position signal Pfb1 detected by the laser interferometer 6 and the second position signal Pfb2 detected by the position sensor 8 to the other. With the present embodiment, to perform high-accuracy positioning, the position controller 10 usually performs integral position control based on the first position signal Pfb1 detected by the laser interferometer 6 and proportional position control based on the second position signal Pfb2 detected by the position sensor 8. However, the first position signal Pfb1 may not be input normally if, for example, the axis of the laser beam of the laser interferometer 6 is blocked. In such a case, the switcher 14 switches the first position signal Pfb1 to the second position signal Pfb2. Thus, the position controller 10 can continue integral position control based on the switched second position signal Pfb2 and proportional position control based on the second position signal Pfb2, and thereby, for example, the workpiece stage 3 can be moved a predetermined stop position and stopped at the stop position. If the first position signal Pfb1 of the laser interferometer 6 becomes normal again, position control using the second position signal Pfb2 may be continued, or the second position signal Pfb2 may be switched back to the first position signal Pfb1 and machining of a workpiece on the workpiece stage 3 may be restarted.

The determiner 13 determines whether or not the first position signal Pfb1 detected by the laser interferometer 6 is input to the position controller 10 normally. The method of determination may be such that it is determined as abnormal when the intensity of light received by the laser interferometer 6, which is an optical detector, becomes lower than a predetermined threshold.

The phase compensator 15 compensates for a phase delay of the feedback signal switched by the switcher 14 (here, a phase delay of the second position signal Pfb2 relative to the first position signal Pfb1) and inputs the feedback signal, for which the phase delay has been compensated, to the position controller 10. The structure of the phase compensator 15 will be described below in detail.

### Detailed Structure of Motor Control Apparatus

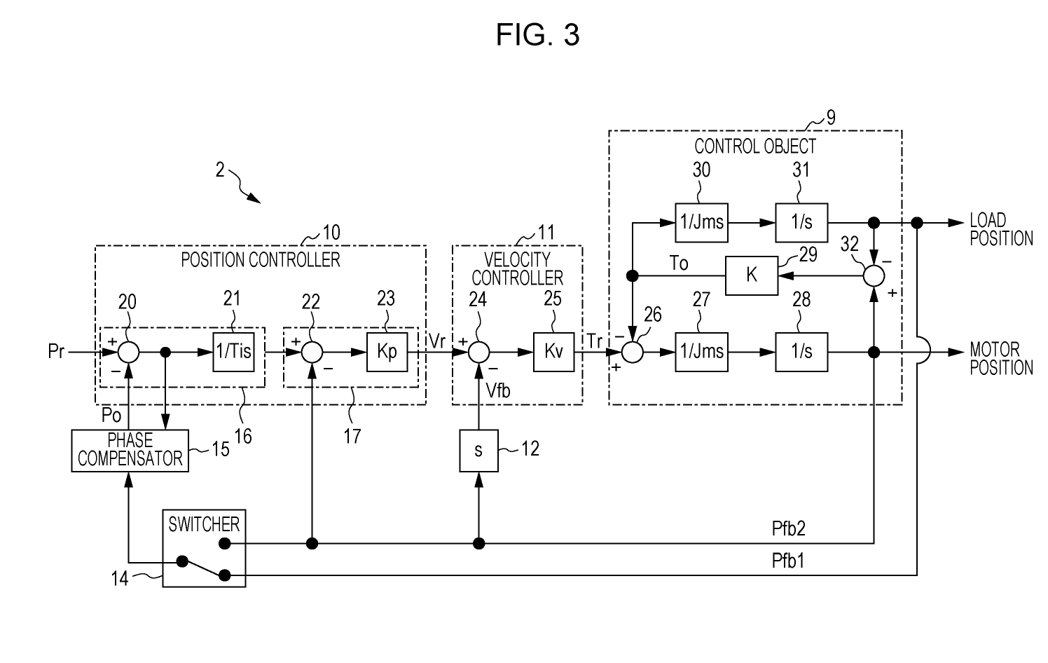

FIG. 3 is a block diagram of an example of the detailed structure of the motor control apparatus 2. In FIG. 3, numerals 20, 22, 24, 26, and 32 denote subtractors; a numeral 21 denotes a position integrator; a numeral 23 denotes a position loop gain; a numeral 25 denotes a velocity loop gain; a numeral 29 denotes a machine spring constant; numerals 27 and 28 denote linear motors; and numerals 30 and 31 denote loads. The position controller 10, the integral position controller 16, the proportional position controller 17, the velocity controller 11, and the controlled object 9 in FIG. 3 respectively correspond to those in FIG. 2.

The first position signal Pfb1 detected by the laser interferometer 6 is input to the phase compensator 15 through the switcher 14 as a feedback signal and changed into a position feedback signal Po (estimated position) for which a phase delay is compensated by the phase compensator 15. Then, the position feed back signal Po is input to the subtractor 20 of the position controller 10. The second position signal Pfb2 detected by the position sensor 8 is input to the subtractor 22 of the position controller 10 as a position feedback signal. The second position signal Pfb2 is also changed into the velocity feedback signal Vfb by the differentiator 12 and input to the subtractor 24 of the velocity controller 11. In addition, the first position signal Pfb1 and the second position signal Pfb2 are input to the subtractor 32 to obtain a position difference, and the position difference is input to the subtractor 26 through the machine spring constant 29.

In the motor control apparatus 2, the subtractor 20 of the integral position controller 16 subtracts a position feedback signal Po from the phase compensator 15 from the position command Pr to obtain a position difference, and the position integrator 21 integrates the position difference. The subtractor 22 of the proportional position controller 17 subtracts the second position signal Pfb2 from the integrated position command to obtain a position difference, and the position difference is multiplied by a gain Kp at the position loop gain 23 to generate the velocity command Vr. The subtractor 24 of the velocity controller 11 subtracts the feedback velocity Vfb from the velocity command Vr to obtain a velocity difference. The velocity difference is multiplied by a gain Kv at the velocity loop gain 25 to generate a torque command Tr, and the torque command Tr is output to the controlled object 9.

In the controlled object 9, the subtractor 32 subtracts the first position signal Pfb1 from the second position signal Pfb2 to obtain a position difference. The position difference is multiplied by the machine spring constant 29 to obtain a torque To, and the subtractor 26 subtracts the torque To from the torque command Tr to obtain a torque difference. The torque difference is integrated by the velocity integrator 27 and is integrated by the integrator 28. In FIG. 3, Jm denotes the mass of a slider of a linear motor. The torque To from the machine spring constant 29 is integrated by the velocity integrator 30 and integrated by the integrator 31. The subtractor 32 represents the difference between the first position signal Pfb1 output from the integrator 31 and the second position signal Pfb2 output from the integrator 28. With a force generated by multiplying the output of the subtractor 32 by the machine spring constant 29, the first position signal Pfb1 and the second position signal Pfb2 are made to coincide with each other.

### Detailed Structure of Phase Compensator

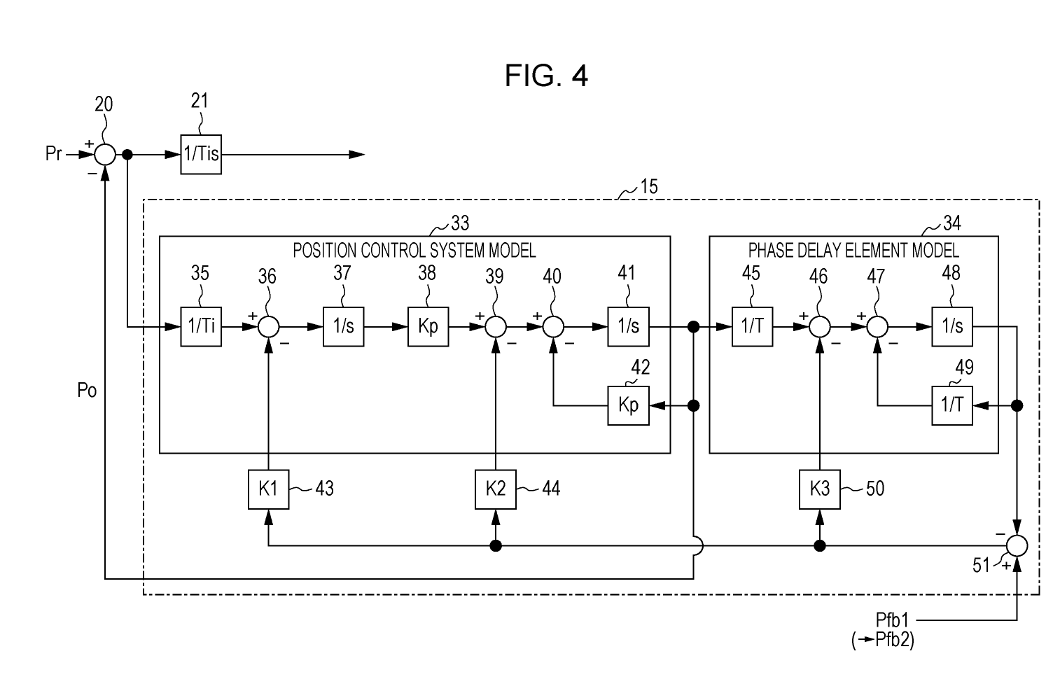

FIG. 4 illustrates an example of the detailed structure of the phase compensator 15. In FIG. 4, the phase compensator 15 includes a position control system model 33 and a phase delay element model 34, and is configured as a so-called phase-control position observer. In FIG. 4, a numeral 35 denotes a position integration gain; numerals 36, 39, 40, 46, 47, and 51 denote subtractors; numerals 37, 41, and 48 denote integrators; numerals 38 and 42 denote position loop gains; numerals 43, 44, and 50 denote observer stabilization gains; and numerals 45 and 49 denote phase delay gains.

A position signal output from the position control system model 33 is input to the subtractor 20 as the position feedback signal Po of the position controller 10 and also input to the phase delay element model 34. A position signal output from the phase delay element model 34 is input to the subtractor 51. The subtractor 51 subtracts the position signal from the first position signal Pfb1 from the laser interferometer 6 (after switching, the second position signal Pfb2 from the position sensor 8, the same applies hereinafter) to obtain a position difference. The position difference is input to the subtractors 36, 39, and 46 respectively through the observer stabilization gains 43, 44, and 50.

In the position control system model 33 of the phase compensator 15, the position difference between the position command Pr and the feedback position Po is multiplied by a gain l/Ti at the position integration gain 35, and the subtractor 36 subtracts a value calculated by multiplying the position difference from the subtractor 51 by a gain K1 at the observer stabilization gain 43. The position difference obtained by the subtractor 36 is integrated by the integrator 37 and multiplied by a gain Kp at the position loop gain 38, and the subtractor 39 subtracts a value calculated by multiplying the position difference from the subtractor 51 by a gain K2 at the observer stabilization gain 44. The subtractor 40 subtracts a value calculated by multiplying a position signal output from the position control system model 33 by a gain Kp at the position loop gain 42 from the position difference obtained by the subtractor 39. The integrator 41 integrates the position difference obtained by the subtractor 40, and the obtained value is output from the position control system model 33 as a position signal.

The position signal output from the position control system model 33 is input to the subtractor 20 as the position feedback signal Po of the position controller 10 and is also input to the phase delay element model 34.

In the phase delay element model 34 of the phase compensator 15, the position signal output from the position control system model 33 is multiplied by a gain l/T at the phase delay gain 45, and the subtractor 46 subtracts a value obtained by multiplying the position difference from the subtractor 51 by a gain K3 at the observer stabilization gain 50. The subtractor 47 subtracts a value obtained by multiplying a position signal output from the phase delay element model 34 by a gain l/T at the phase delay gain 49 from the position difference obtained by the subtractor 46 to calculate a position difference. The integrator 48 integrates the position difference, and the obtained value is output from the phase delay element model 34 as a position signal. The subtractor 51 subtracts the position signal output from the phase delay element model 34 from the first position signal Pfb1 from the laser interferometer 6. With such a structure, the phase compensator 15 performs control so that the position signal output from the phase delay element model 34 coincides with the first position signal Pfb1.

The phase of the position signal output from the phase delay element model 34 is delayed relative that of the position signal output from the position control system model 33. Thus, the phase of the position signal from the position control system model 33 is advanced relative to the first position signal Pfb1 (after being switched, the second position signal Pfb2 input from the position sensor 8) input from the laser interferometer 6. By outputting the position signal with advanced phase to the position controller 10, even if a phase delay occurs when switching from the first position signal Pfb1 to the second position signal Pfb2, the position feedback signal Po input to the position controller 10 can be made to be a position signal without phase delay.

### Advantage of Embodiment

With the motor control apparatus 2 according to the present embodiment, the switcher 14 switches a position feedback signal to be input to the integral position controller 16 of the position controller 10 from the first position signal Pfb1 detected by the laser interferometer 6 to the second position signal Pfb2 detected by the position sensor 8. When switching between position detectors used for position control, a shock (sharp change in motor velocity) may occur due to the following reasons: an error in a position signal due to the difference between objects to be detected by the position detectors and time lag for switching; and a phase delay of a position signal due to a delay of a control cycle and a delay of communication time between the detectors.

In the present embodiment, the motor control apparatus 2 includes the phase compensator 15. The phase compensator 15 can compensate for the phase delay of the second position signal Pfb2 switched by the switcher 14 relative to the first position signal Pfb1, and can interpolate an error between the first position signal Pfb1 and the second position signal Pfb2. Therefore, occurrence of a shock when switching between the position detectors can be reduced. Moreover, with the phase compensator 15, there is an advantage in that the rising edge and the falling edge of the motor velocity can be made smooth and the response of the control system can be made close to ideal characteristics.

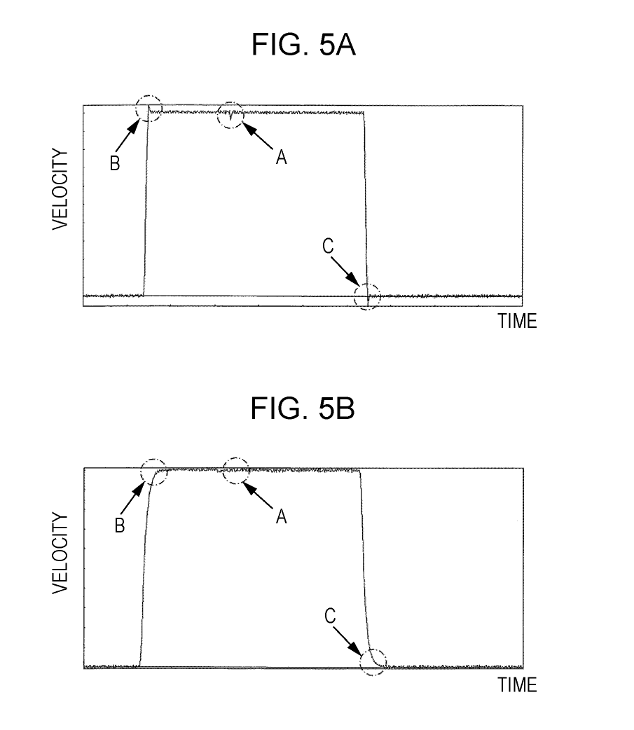

This advantage will be described with reference to FIGS. 5A and 5B. FIG. 5A shows a waveform graph of a motor velocity of a motor control apparatus that does not include the phase compensator 15, and FIG. 5B shows a waveform graph of a motor velocity of the motor control apparatus 2 that includes the phase compensator 15. With a comparative example, which does not include the phase compensator 15, a shock (sharp change in motor velocity) occurs as indicated by an arrow A in FIG. 5A when the position detector is switched from the laser interferometer 6 to the position sensor 8. Moreover, sharp edges are generated at the rising edge and the falling edge of the waveform of motor velocity as indicated by arrows B and C in FIG. 5A.

In contrast, with the present embodiment, which includes the phase compensator 15, occurrence of a shock when switching the position detector from the laser interferometer 6 to the position sensor 8 can be reduced as illustrated FIG. 5B. Moreover, there are no sharp edges at the rising edge and the falling edge of the waveform of motor velocity, and the motor velocity can be changed smoothly.

In addition, the following advantage can be obtained with the present embodiment. That is, if the position feedback signal is not input normally while position controller 10 is performing position control on the basis of the position difference between the position command Pr and the position feedback signal, positioning operation may be disabled and malfunction or the like of a device that is a driving object, such as the workpiece stage 3, may occur. With the present embodiment, the determiner 13 determines whether or not the first position signal Pfb1 from the laser interferometer 6 is input to the position controller 10 normally. If the determiner 13 determines that the first position signal Pfb1 is not normal, the switcher 14 switches the first position signal Pfb1 to the second position signal Pfb2. Thus, the position controller 10 can position the workpiece stage 3 at a predetermined stop position and stop the workpiece stage 3 at the stop position by using the switched second position signal Pfb2, and thereby malfunction or the like of a device that is a driving object can be prevented.

In particular, with the present embodiment, the position controller 10 performs integral position control using the laser interferometer 6 and proportional position control using the position sensor 8, and thereby a smooth response can be obtained and the number of peaks of torque is reduced and therefore a load applied to a device that is the driving object, such as the workpiece stage 3, can be reduced. Moreover, after the switcher 14 has performed switching, the position controller 10 can continue integral position control using the position sensor 8 and the proportional position control using the position sensor 8, and thereby a good response and the like can be maintained.

### Modifications

Hereinafter, modifications of the embodiment will be sequentially described.

(1) Modification with which Position Signal is Corrected using Correlation Table

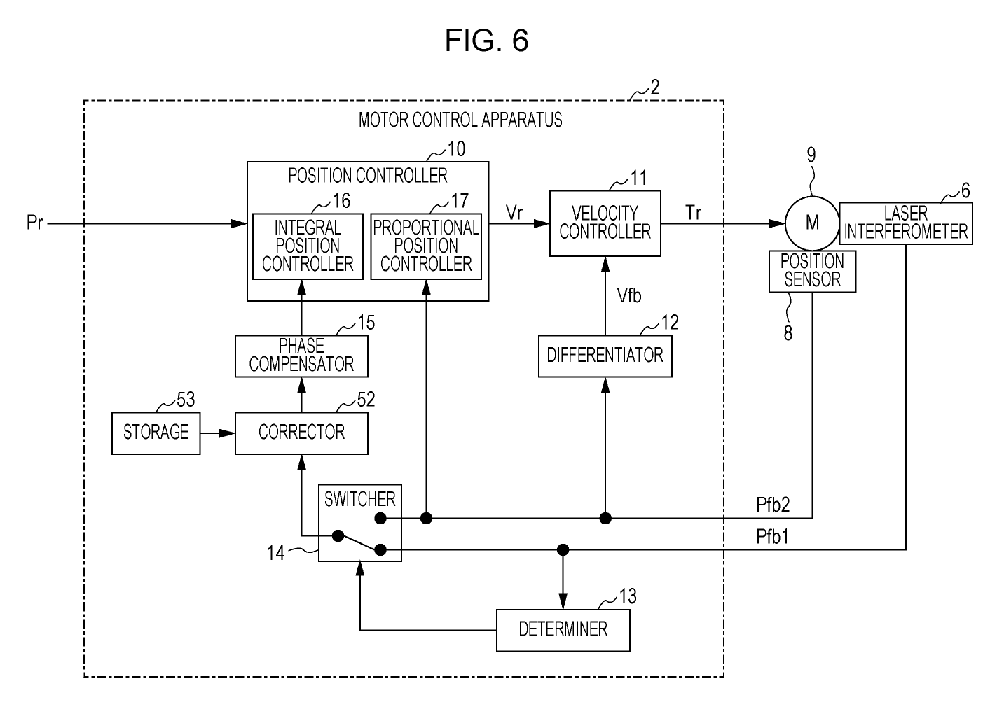

In the embodiment described above, it is assumed that the workpiece stage 3 is stopped and machining of a workpiece is stopped when switching from the first position signal Pfb1 detected by the laser interferometer 6 to the second position signal Pfb2 detected by the position sensor 8 is performed. However, there may be a need to continue machining of a workpiece. If machining of a workpiece is continued with the embodiment described above, the accuracy of machining may decrease after the position signals have been switched and a defect of the workpiece may occur, because the laser interferometer 6 generally has detection accuracy higher than that of the position sensor 8. Therefore, a corrector using a correlation table may be provided to make the position signal after switching coincide with the position signal before switching. Referring to FIG. 6, an example of the present modification will be described.

As illustrated in FIG. 6, a motor control apparatus 2 according to the present modification includes a corrector 52 and a storage 53. The storage 53 stores a correlation table used by the corrector 52. The correlation table contains the correlation (the difference and the like) between the first position signal Pfb1 and the second position signal Pfb2. The correlation table is made by, for example, making the controlled object 9 perform uniform linear motion and simultaneously recording detection data of the laser interferometer 6 and detection data of the position sensor 8 for one stroke of the motion.

When the switcher 14 switches from the first position signal Pfb1 to the second position signal Pfb2, the corrector 52 performs correction so that the second position signal Pfb2 after switching coincides with the first position signal Pfb1 before switching on basis of the correction table stored in the storage 53. The corrected first position signal Pfb1 is input to the phase compensator 15. Thus, decrease in the accuracy of detection when the position detectors are switched can be prevented. Therefore, machining of a workpiece can be continued and thereby the yield can be increased.

### (2) Other Modifications

Heretofore, examples in which the position detector is switched from the laser interferometer 6 to the position sensor 8 (linear scale 7) have been described. Switching of position detector may be performed in various other ways. For example, conversely, switching may be performed from the position sensor 8 to the laser interferometer 6. In this case, the determiner 13 may determine whether or not the second position signal Pfb2 is normal. If a linear encoder, an external encoder, or the like is used as a position detector, switching may be performed from the laser interferometer 6 to the linear encoder, from the external encoder to the position sensor 8 (linear scale 7), and in various other ways. In any of these cases, advantages the same as those of the embodiment described above can be obtained.

Heretofore, a linear motor is used as an example. However, a rotary motor may be used. Also in this case, the position detector may be switched from the position sensor 8 (linear scale 7) to the rotary encoder, and in various other ways. When a rotary motor is used, advantages the same as those of the embodiment described above can be obtained.

In addition, methods used in the embodiment and modifications described above may be appropriately used in combination.

It should be understood by those skilled in the art that various modifications, combinations, sub-combinations and alterations may occur depending on design requirements and other factors insofar as they are within the scope of the appended claims or the equivalents thereof.

What is claimed is:

1. A motor control apparatus comprising:
a position controller that generates a velocity command on the basis of a position difference between a position command and a position feedback signal;
a switcher that switches the position feedback signal to be input to the position controller from one of a first position signal detected by a first position detector and a second position signal detected by a second position detector to the other; and
a phase compensator that compensates for a phase delay of the first position signal or the second position signal switched by the switcher.

2. The motor control apparatus according to claim 1,
wherein the phase compensator includes
a position control system model to which the position difference is input and from which the position feedback signal is output, and
a phase delay element model to which an output of the position control system model is input and from which an output that is the same as the first position signal or the second position signal is output.

3. The motor control apparatus according to claim 1, further comprising:
a storage that stores a correlation table containing a correlation between the first position signal and the second position signal; and
a corrector that performs correction, when the switcher switches from one of the first position signal and the second position signal to the other, so that the position signal after switching coincides with the position signal before switching on the basis of the correlation table.

4. The motor control apparatus according to claim 1, further comprising:
a determiner that determines whether or not the first position signal from the first position detector or the second position signal from the second position detector is input to the position controller normally,
wherein the switcher switches one of the position signals that is determined as not normal to the other.

5. The motor control apparatus according to claim 4,
wherein the determiner determines whether or not the first position signal detected by the first position detector is input to the position controller normally, and
wherein the switcher switches the first position signal to the second position signal detected by the second position detector when the determiner determines that the first position signal is not input normally.

6. The motor control apparatus according to claim 1,
wherein the position controller includes
an integral position controller that performs integral position control based on the first position signal, and
a proportional position controller that performs proportional position control based on the second position signal, and
wherein the switcher switches the position feedback signal to be input to the integral position controller from the first position signal to the second position signal.

7. A motor control apparatus comprising:
position control means for generating a velocity command on the basis of a position difference between a position command and a position feedback signal;
switching means for switching the position feedback signal to be input to the position control means from one of a first position signal detected by a first position detector and a second position signal detected by a second position detector to the other; and
phase compensation means for compensating for a phase delay of the first position signal or the second position signal switched by the switching means.
